(19) United States
(12) Patent Application Publication
(10) Pub. No.: US 2026/0153862 A1
(43) Pub. Date: Jun. 4, 2026

(54) A METHOD AND SYSTEM FOR ANOMALY DETECTION IN AN OPERATIONAL ASSET, AND A METHOD FOR REPAIRING AN OPERATIONAL ASSET

(71) Applicant: Mitsubishi Electric Corporation, Tokyo (JP)

(72) Inventors: Toshiyuki KURIYAMA, Tokyo (JP); Koji WAKIMOTO, Tokyo (JP); Shinya TSURUTA, Tokyo (JP); Takaaki NAKAMURA, Tokyo (JP); Shahin SIAHPOUR, Cincinnati, OH (US); Abhijeet AINAPURE, Blue Ash, OH (US); John Oliver TACO LOPEZ, Cincinnati, OH (US); Marcella MILLER, Cincinnati, OH (US); Jay LEE, Rockville, MD (US)

(73) Assignee: Mitsubishi Electric Corporation, Tokyo (JP)

(21) Appl. No.: 19/123,281

(22) PCT Filed: Dec. 8, 2023
(86) PCT No.: PCT/US2023/083115

§ 371 Date: Apr. 22, 2025

Related U.S. Application Data
(60) Provisional application No. 63/431,384, filed on Dec. 9, 2022.

(51) Int. Cl. G05B 23/02

(52) U.S. Cl. CPC G05B 23/024

(57) ABSTRACT

A method for anomaly detection in an operational asset includes collecting a source domain dataset corresponding to a first operating condition of the operational asset, wherein samples from the source domain dataset belong to a healthy class, and a faulty class; collecting a target domain dataset corresponding to a second operation condition of the operational asset, wherein samples from the target domain dataset belong to the healthy class; inputting the source domain dataset and the target domain dataset as input data into a neural network; extracting, by the neural network, features from the input data, wherein a first subset of features is discriminative of the healthy class and a second subset of features is domain invariant; reducing a dimensionality of the features into reduced features; and classifying the reduced features into a normal class and an anomaly class using a one-class classifier.

### CROSS REFERENCE TO RELATED APPLICATION

This application claims priority to U.S. Provisional Application Ser. No. 63/431,384, filed Dec. 9, 2022, the entire contents of which are incorporated herein by reference.

### TECHNICAL FIELD

The present invention relates to tools for monitoring operational or industrial asset health.

### BACKGROUND

Operational or industrial assets or machines are run within different “domains” or “operating regimes,” including, for example, different rotational speeds, environmental temperatures, and loads. For the same machine status (e.g., healthy, fault type I, fault type II, etc.), the data signature might be different due to the operating regime. For example, the vibration of a fault type I machine at 50 RPM might be similar to the vibration of a healthy machine at 100 RPM. This difference is “domain discrepancy,” and domain adaptation must be applied to remove the domain discrepancy. Transfer learning seeks to use knowledge gained from solving a problem in one domain (“source”) to augment and enhance problem solving techniques in another domain (“target”).

### SUMMARY

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

In one embodiment, a method for anomaly detection in an operational asset includes collecting a source domain dataset corresponding to a first operating condition of the operational asset, wherein samples from the source domain dataset belong to a healthy class, and a faulty class; collecting a target domain dataset corresponding to a second operation condition of the operational asset, wherein samples from the target domain dataset belong to the healthy class; inputting the source domain dataset and the target domain dataset as input data into a neural network; extracting, by the neural network, features from the input data, wherein a first subset of features is discriminative of the healthy class and a second subset of features is domain invariant; reducing a dimensionality of the features into reduced features; and classifying the reduced features into a normal class and an anomaly class using a one-class classifier.

In another embodiment, a system for anomaly detection in an operational asset, includes one or more processors; and a non-transitory computer-readable medium storing instructions that, when executed by the one or more processors, cause the one or more processors to: receive a source domain dataset corresponding to a first operating condition of the operational asset, wherein samples from the source domain dataset belong to a healthy class, and a faulty class; receive a target domain dataset corresponding to a second operation condition of the operational asset, wherein samples from the target domain dataset belong to the healthy class; input the source domain dataset and the target domain dataset as input data into a neural network; extract, by the neural network, features from the input data, wherein a first subset of features is discriminative of the healthy class and a second subset of features is domain invariant; reduce a dimensionality of the features into reduced features; and classify the reduced features into a normal class and an anomaly class using a one-class classifier.

In yet another embodiment, a method for repairing an operational asset includes collecting a source domain dataset corresponding to a first operating condition of the operational asset, wherein samples from the source domain dataset belong to a healthy class, and a faulty class; collecting a target domain dataset corresponding to a second operation condition of the operational asset, wherein samples from the target domain dataset belong to the healthy class; inputting the source domain dataset and the target domain dataset as input data into a neural network; extracting, by the neural network, features from the input data, wherein a first subset of features is discriminative of the healthy class and a second subset of features is domain invariant; reducing a dimensionality of the features into reduced features; classifying the reduced features into a normal class and an anomaly class using a one-class classifier; identifying at least one operational asset within the anomaly class; and repairing the at least one operational asset.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a method for feature extraction using a neural network, such as a convolutional neural network (CNN), according to one or more embodiments shown and described herein;

FIG. 1B schematically depicts a method for anomaly detection using a one-class support vector machine, according to one or more embodiments shown and described herein;

FIG. 2A schematically depicts an overall architecture of a neural network, according to one or more embodiments shown and described herein;

FIG. 2B schematically depicts an overall architecture of an anomaly detection framework, according to one or more embodiments shown and described herein;

FIG. 3 schematically depicts a system for anomaly detection in an operational asset, according to one or more embodiments shown and described herein;

FIG. 4 schematically depicts an experimental setup for a manufacturing system utilizing a gear box, according to one or more embodiments shown and described herein;

FIG. 5 depicts a studied gearbox and representative wear fault conditions of the gearbox, according to one or more embodiments shown and described herein;

FIG. 6 schematically depicts a comparative study of the performance of the exemplary anomaly detection method, according to one or more embodiments shown and described herein;

FIG. 7A schematically depicts the anomaly detection performance of the exemplary anomaly detection method for a task where the value of the term v is =0.005, where v affects the number of samples considered as outliers, according to one or more embodiments shown and described herein;

FIG. 7B schematically depicts the anomaly detection performance of the exemplary anomaly detection method for a task where the value of the term v is =0.5, where v affects the number of samples considered as outliers, according to one or more embodiments shown and described herein;

FIG. 7C schematically depicts the anomaly detection performance of the exemplary anomaly detection method for a task where the value of the term v is =0.01, where v affects the number of samples considered as outliers, according to one or more embodiments shown and described herein;

FIG. 8 schematically depicts a high-level feature visualization of the raw data used in the exemplary anomaly detection method, according to one or more embodiments shown and described herein; and

FIG. 9 schematically depicts the anomaly detection results for a one-class support vector machine, according to one or more embodiments shown and described herein.

### DETAILED DESCRIPTION

Reference will now be made in detail to various embodiments of methods and systems for anomaly detection in operational assets (e.g., any mechanical or electrical equipment), examples of which are illustrated in the accompanying drawings. It is noted that the term “operational asset” is also referred synonymously with the term “industrial asset” herein, although embodiments are not limited to industrial equipment. Whenever possible, the same reference numerals will be used throughout the drawings to refer to the same or like parts.

In industrial settings, assets or equipment, such as a gearbox, often play a critical role in various applications, such as, for example, wind turbines, conveyors, or industrial robots. These and other applications rely on properly functioning industrial assets to sustain energy output, move parts on a manufacturing floor, or maintain the necessary precise motions and throughput for material handling and production, for example. Due to the complexities of many industrial assets, which make them susceptible to multiple different modes of degradation, including wear and corrosion, close monitoring of the assets is essential to avoid the unexpected downtime, loss of production, damage to materials, and potentially unsafe conditions that could arise from a faulty component. Although industrial assets are designed for maximum life expectancy in a demanding environment, the continuous motion of these assets inevitably leads to degradation over time. Thus, early and accurate identification of the health condition of industrial assets is critical.

Traditionally, signal processing techniques are applied to vibrational data of industrial assets, such as the gearbox, for prognostics and health management (PHM). However, neural networks can also be utilized in industrial asset monitoring. For example, convolutional neural networks (CNN) can be applied for the analysis of vibration signals from an operational asset. In addition, deep learning strategies can be utilized and offer benefits over traditional machine learning techniques and neural network approaches. For example, a deep learning architecture can perform automatic feature selection within its multiple hidden layers, and bypassing the typically required feature extraction and selection steps decreases the time it takes to implement a fault identification method. Furthermore, the features mined by deep learning architectures are more sensitive and information dense than those extracted through classical means.

Although the data-driven aspects of deep learning are also a key benefit, obtaining data for every possible working regime and machine state is not always easy or even possible. As such, it is important to develop and expand the techniques which allow for fault identification and health assessment to be performed with only a subset of the full range of possible conditions available. Therefore, applications of transfer learning are described herein to allow knowledge from one machine state to be used to augment the assessment of other unseen or less documented conditions.

While transfer learning solves the issue of limited data, additional obstacles within the field of transfer learning are addressed by the present disclosure. One key challenge in transfer learning is domain discrepancy. When transferring knowledge from the source domain to the target domain, a shift in the underlying domain distribution can impact the accuracy of results. To avoid misclassifications, the present disclosure applies domain adaptation methods to overcome the domain discrepancy.

In a practical industrial setting, it is often most feasible to perform domain adaptation on the healthy or baseline class from various domains. Once the domain discrepancy is overcome and the healthy machine states are aligned, the deep learning methods disclosed herein can be used to identify outlier samples that do not fall within the expected range of the healthy condition. Such application of anomaly detection allows the development of industrial asset degradation to be tracked over the life cycle of the components, and samples that appear as anomalous can trigger necessary maintenance actions to avoid additional damage in critical and costly components, such as robotic arms, for example.

As will be described in various embodiments of the present disclosure, methods and systems disclosed herein utilize deep learning approaches with domain adaptation across different machine states with the goal of improving anomaly detection for industrial assets. The methods and systems disclosed herein overcome the need for data to be collected for all operating conditions of an industrial asset and can be expanded to other industrial applications in which it is not feasible to collect an exhaustive dataset, thereby saving significant time required for training data collection and computational resources for processing such training data. That is, the deep learning-based domain adaptation approaches of the present disclosure permit the transfer of knowledge obtained from one operating condition to another. In this regard, the methods and systems utilize a two-stage approach to extract domain-invariant and healthy class discriminative features from raw data and subsequently use these features in a one-class classifier for anomaly detection. Moreover, the deep learning approaches disclosed herein are able to account for machine-to-machine variations or the effects of environmental conditions.

One skilled in the art will recognize that the various embodiments of the present disclosure may be practiced without one or more of the specific details described herein, or with other replacement and/or additional methods, materials, or components. In other instances, well-known structures, materials, or operations are not shown or described in detail herein to avoid obscuring aspects of various embodiments of the invention. Similarly, for purposes of explanation, specific numbers, materials, and configurations are set forth herein in order to provide a thorough understanding of the various embodiments of the present disclosure. Furthermore, it is understood that the various embodiments shown in the figures are illustrative representations and are not necessarily drawn to scale.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any device or assembly claim does not actually recite an order or orientation to individual components, or it is not otherwise specifically stated in the claims or description that the steps are to be limited to a specific order, or that a specific order or orientation to components of an device or assembly is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

Reference throughout the present disclosure to “one embodiment” or “an embodiment” means that a particular feature, structure, material, or characteristic described in connection with the embodiment is included in at least one embodiment of the invention but does not denote that they are present in every embodiment. Thus, the appearances of the phrases “in an embodiment” or “in another embodiment” in various places throughout this specification are not necessarily referring to the same embodiment of the invention. Further, as used herein, the singular forms “a,” “an,” and “the” include plural referents unless the context clearly dictates otherwise. Thus, for example, reference to “a” component includes aspects having two or more such components, unless the context clearly indicates otherwise. In addition, “a component” may be representative of one or more components and, thus, may be used herein to mean “at least one.”

In the present disclosure, a transfer learning approach is utilized to tackle anomaly detection problems. In this case, the data corresponding to the source domain contains all three health classes (e.g., healthy, between, and faulty) while only the healthy state of the system is available for the target domain dataset. Let

$${D}_{s} = {\{ ( {x}_{s}^{i} , {y}_{s}^{i} ) \}}_{i = 1}^{{n}_{s}} and {D}_{t} = {\{ ( {x}_{t}^{i} , {y}_{t}^{i} ) \}}_{i = 1}^{{n}_{t}}$$

denote the source and target domains, respectively. Note that

$${x}_{s}^{i} , {y}_{s}^{i} , {x}_{t}^{i} , and {y}_{t}^{i}$$

represent the ith sample and health label, and nₛ and nₜ are the number of samples corresponding to the source and target domain. The goal is to generate domain-invariant and healthy class discriminative features that can be used for both the source and target domain dataset for anomaly detection purposes. Since only the healthy class corresponding to the target domain is used for domain adaptation, the methodology is designated as conditional domain adaptation (CDA).

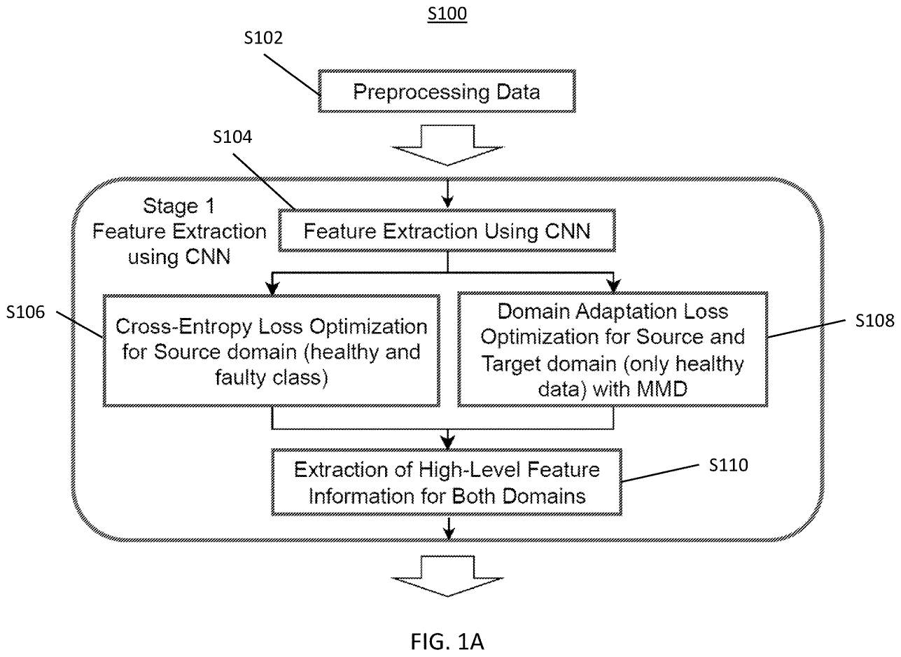

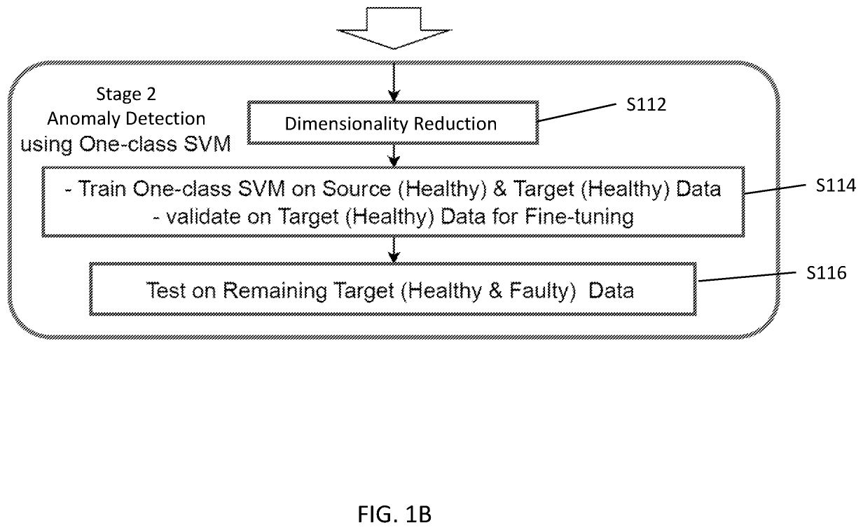

Referring to FIGS. 1A and 1B, a flowchart is shown which illustrates a two-stage anomaly detection methodology or architecture S100 in accordance with embodiments of the present disclosure. The first stage is generally referred to as feature extraction using a neural network, such as a CNN, and is illustrated in FIG. 1A. The method begins at S102 with the preprocessing of data prior to performing the first stage. The preprocessing of data at S102 generally includes preparing input data samples and labels for both a source domain and a target domain. Once the source and target domain input data samples are prepared and labeled, the data samples are input into a CNN at S104. At S104, the CNN has been trained to extract healthy class discriminative features that separate healthy samples from all the other classes (e.g., “between” class and “faulty” class) and to extract domain-invariant features that are aligned in the feature space for all domains. In particular, the CNN is trained to extract features that satisfy the healthy class discriminative, domain-invariant requirements by using a two-part loss function at S106 and S108. The first of the two-part loss functions, cross-entropy loss optimization, is applied at S106 to update the CNN to separate the healthy class from all other classes. That is, the cross-entropy loss optimization at S106 considers all classes for the source domain and only the healthy class for the target domain. The second of the two-part loss functions, domain adaptation loss optimization, is applied at S108 using maximum mean discrepancy (MMD) to update the CNN so that the domain discrepancy between the source domain and target domain healthy class samples is minimized. That is, the domain adaptation loss optimization using MMD at S108 only considers healthy class samples from the source domain and the target domain. After application of the two-part loss function at S106 and S108, the CNN extracts high-level feature information for both the source domain and the target domain at S110 and the first stage is complete.

The second stage is generally referred to as anomaly detection using a one-class support vector machine (SVM) and is illustrated in FIG. 1B. The second stage generally utilizes the high-level features extracted from the trained CNN in the first stage to perform the ultimate task of anomaly detection. The second stage begins at S112, where the dimensionality of the problem is reduced through the application of t-distributed stochastic neighbor embedding (t-SNE). Then, at S114, health labels are assigned to each sample through the application of a one-class classifier (e.g., one-class SVM). In particular, at S114, the one-class SVM is trained on healthy data from the source domain and healthy data from the target domain, and the one-class SVM is validated on healthy data from the target domain for fine-tuning. Then, at S116, the one-class SVM tests remaining data from the target domain (including healthy and faulty data). In general, at S114 and S116, the one-class SVM method is applied to detect samples that are outliers of the healthy class (i.e., anomalous or abnormal samples corresponding to a likely fault in the machine). The anomaly detection method of the second stage is able to detect abnormal samples in the target domain without having seen any abnormal samples during training. Steps S102-S116 of example method S100 will now be discussed in greater detail.

Method step S102 is directed to the preprocessing of data which generally includes preparing input data samples and labels for both a source domain and a target domain. In particular, fixed cycle feature test (FCFT) data is obtained by running preset operating patterns repeatedly at different times in the life cycle of an industrial asset or machine. The preset patterns cover a wide range of operating conditions (e.g., minimum and maximum rotational speeds). Since the machine is running the same patterns at all points in the life cycle, changes in the collected data are due to machine degradation. In accordance with some embodiments of the present disclosure, a method to generate appropriate frequency-domain samples from feedback torque current data obtained via FCFT can be defined. The FCFT data is collected for various health conditions. For each health condition, there are multiple repetitions of the FCFT command patterns (characterized by different rotational direction and position commands) run for each of the main operating regimes (rotational speeds), with multiple patterns occurring for each operating regime (e.g. collect 100 repetitions of 48 patterns (12 each for 50, 500, 1000, 3000 RPM)). The collected command velocity signal is used to reduce each pattern to contain only steady state portions of the feedback torque current signal. These are further reduced by removing a preset percentage of the initial points to guarantee that the steady state condition is achieved. All cleaned, steady state patterns for one health condition are concatenated across all repetitions to create one continuous feedback torque current signal. This torque signal is used to generate the frequency-domain samples. A pre-determined number of samples of a specified length are acquired by splitting the torque signal in the time-domain and then saving the frequency-domain information of each segment as one of the final samples. These frequency-domain samples are then ready for feature extraction using CNN.

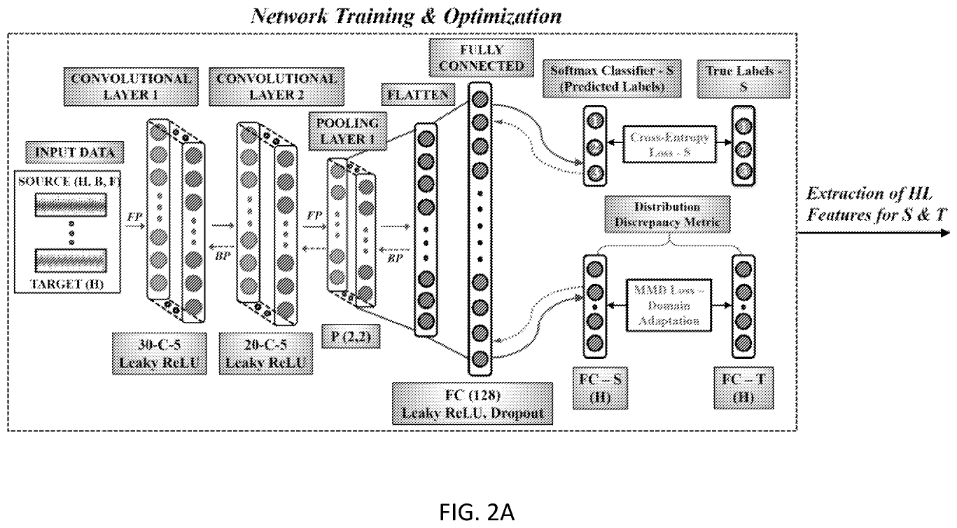

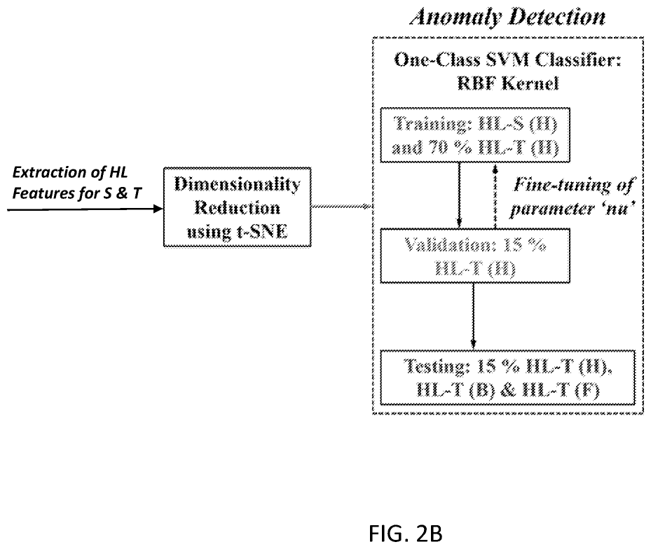

Method step S104 is directed to feature extraction using a CNN architecture. An example CNN architecture in accordance with embodiments of the present disclosure is illustrated in FIG. 2A. As a feature extraction module, a CNN architecture is exploited to extract the useful information from the raw input data. This architecture combines convolution, pooling, and fully connected (FC) layers. The convolution layers are mostly responsible for extracting the meaningful information out of the input data. In this process, the higher-dimensional input data is generally converted into the lower-dimensional output features. In other words, the features are automatically extracted without prior knowledge about the input data. Let

$${f}_{j}^{l}$$

be the jth feature map at the lth later while the term

$${w}_{ij}^{l}$$

represents the kernel that connects the ith feature map to the jth feature map at the lth layer with the bias of

$${b}_{j}^{l} .$$

By convolving the feature map with kernels, the features can be extracted as shown in Equation (1) below:

$${f}_{j}^{l} = {\sum }_{i} {f}_{i}^{l - 1} * {w}_{ij}^{l} + {b}_{j}^{l} \qquad ( 1 )$$

where * is the convolution operation. Furthermore, a nonlinear activation function is applied to the feature maps to capture the non-linearity correlation between the features and data. To further reduce the dimension of the feature maps, a pooling layer can follow the convolution layers. The max pooling technique is used to keep the meaningful spatial information of the feature map while simultaneously reducing the dimensionality.

With respect to MMD, let Eₕ_{^{s}}_{˜p}_{^{s}}[Ø(h^{s})] indicate the mathematical expectation of Ø(h^{s}) where the source domain high-level features, h^{s}, are under probability distribution P^{s}, and let Eₕ_{^{t}}_{˜p}_{^{t}}[Ø(h^{t})] indicate the mathematical expectation of Ø(h^{t}) where the target domain high-level features, h^{t}, are under probability distribution P^{t}. The interpretation of MMD as the squared distance between the kernel embeddings of marginal distributions in the reproducing kernel Hilbert space (RKHS) can be defined as shown in Equation (2) below:

$${MMD}^{2} ( {P}^{s} , {P}^{t} ) \hat{=} \begin{matrix}sup \\ ‖ ∅ ‖ ℋ \leq 1\end{matrix} ‖ {E}_{{h}^{s} \sim {P}^{s}} [ ∅ ( {h}^{s} ) ] - {E}_{{h}^{t} \sim {P}^{t}} [ ∅ ( {h}^{t} ) ] ‖ \qquad ( 2 )$$

where Ø(·) and sup(·) denote the mapping function and the supremum of the input aggregate, respectively. Notice that ∥Ø∥ [symbol] ≤1 explains a set of functions in the unit ball of RKHS [symbol] . In a case where P^{s}=P^{t}, based on the statistical tests, MMD(P^{s}, P^{t})=0 and vice versa. The MMD calculation method is highly affected by the choice of kernels. Therefore, the power of multiple kernels (MK) is exploited by a combination of five radial base function (RBF) kernels.

With respect to a one-class model of SVM of Stage 2, an unsupervised model of machine learning is denoted that generates a decision function for estimating the outliers among the dataset. In this approach, the model is trained using one class of the data (typically the normal or healthy class). The knowledge obtained from the trained model can be used to identify whether the test data are similar to or different from the training dataset. In most of the real-world applications, collecting data from the anomaly classes is not a straightforward task. Therefore, when using one-class SVM for anomaly detection purposes, the model can be trained using only the healthy or normal class dataset without the need to use other classes.

The one-class SVM model produces a nonlinear decision boundary by mapping the original feature space into the higher dimensional spaces. The mapping transformation is properly carried out using kernel functions. By assuming X and Y denote the original and high-dimensional feature spaces (Ø:X→Y), the one-class SVM model can be trained using the following Equations (3):

$${min}_{ω , ξ , b} \frac{1}{2} {‖ ω ‖}_{2}^{2} + \frac{1}{vm} {\sum }_{i = 1}^{m} {ξ}_{i} - b \qquad ( 3 )$$

$$s . t . ∀ i = 1 , 2 , … , N$$

$$v ∈ ( 0 , 1 ] , {ξ}_{i} \geq 0 ,$$

$$ω \cdot ∅ ( {x}_{i} ) \geq b - {ξ}_{i} .$$

where ξᵢ represents the slack variable. The term v is responsible for excluding a fraction of the training dataset as outliers. The following Equation (4) is a decision function used to distinguish the anomalies in the dataset:

$$f ( x ) = sign ( ω \cdot ∅ ( x ) - b ) = \{ \begin{matrix}+ 1 Normal \\ - 1 Outlier\end{matrix} . \qquad ( 4 )$$

In the present disclosure, the radial basis function (RBF) kernels are used to transform the original feature space into the higher dimension space.

As shown in FIG. 2A, the CNN architecture of Stage 1 of FIG. 1A includes four main modules in two stages. The four main modules include, in the first stage, a deep learning-based feature extraction module and a domain adaptation module, and in the second stage, a dimension reduction module and a one-class classifier module. At the first stage, which includes network training and optimization, the deep learning-based feature extractor module extracts meaningful information from the raw input data in the form of low-dimension high-level (HL) features. The frequency spectrum of the collected data is used as the input data. The HL features are then fed to the domain adaptation module. The main responsibility of the domain adaptation module is to generate the domain-invariant features. In other words, the domain adaptation module reduces the discrepancy between the feature representations corresponding to the source and target domain. At the first stage, the network is trained using the source data, which encompasses all classes (H-healthy, B-between, and F-faulty), and the target domain with only the healthy class. Therefore, the major goal of the first stage is to extract the features that are both domain-invariant and discriminative of the healthy class. Note that at the first stage, all health classes of the system are available for the source domain dataset, but only the healthy class is available for the target domain dataset. Missing labels in the target domain may affect the transferability of the CNN, and the features may not be completely discriminative of the healthy class. To address this issue, a second stage (FIG. 2B) is added to the CNN to improve the anomaly detection capability of the features. In the second stage of the architecture illustrated in FIG. 2B, the features are used as the input of a one-class classifier for fulfilling the anomaly detection intentions; however, a dimension reduction module is provided to first reduce the feature dimensions to decrease the complexity of the input data while maintaining the useful information. In this regard, the t-distributed stochastic neighbor embedding (t-SNE) is exploited.

To achieve transfer learning across domains, method step S106 is directed to cross-entropy loss optimization to update the CNN to separate the healthy class from all other classes, while method step S108 is directed to domain adaptation loss optimization using maximum mean discrepancy (MMD) to update the CNN so that the domain discrepancy between the source domain and target domain healthy class samples is minimized. Thus, at the first stage, the goal is to create features that are both discriminative of the healthy class and domain-invariant. To satisfy the healthy class discrimination, a typical classification loss function, the cross-entropy loss, is used as shown in Equation (5) below:

$${L}_{C} = \frac{1}{n} {\sum }_{i = 1}^{n} {\sum }_{j = 1}^{{N}_{c}} 1 \{ {y}_{i} = j \} log ( {y}_{ij}^{′} ) \qquad ( 5 )$$

where n, N_{c}, yᵢ, y′ᵢⱼ are the number of samples, the number of classes in each domain, the label corresponding to the ith sample, and the predicted label corresponding to the ith sample and jth class, respectively.

To transfer the knowledge obtained from the source domain to the target domain, a domain adaptation methodology is deployed. The data corresponding to the source and target domains are collected under different working regimes, which can affect the data distribution (and corresponding feature representation) across the domains. To tackle this issue, the MMD metric is utilized to measure the discrepancy between the data distribution of source and target domains. The MMD term is added to the total optimization goals as a loss function. The MMD loss function is defined in Equation (6) below:

$${L}_{DA} = MMD ( {F}_{source} , {F}_{target} ) \qquad ( 6 )$$

where the arguments F_{source} and F_{target} are the feature representations of the data corresponding to the source and target domains, respectively.

In summary, combining the loss functions of Equations (5) and (6) above forms the general optimization goal of the exemplary CNN architecture. Therefore, by integrating Equations (5) and (6), the following general loss function can be formulated as shown in Equation (7) below:

$${L}_{tot} = α {L}_{C} + β {L}_{DA} \qquad ( 7 )$$

where α>0 and β>0 are the penalty coefficients for L_{C} and L_{DA}, respectively. During the training stage, the network parameters of the feature extractor module, θ_{f}, and one-class classifier module, θ_{c}, are optimized and updated according to the loss function. The updating process can be formulated as shown in Equation (8) below:

$$θ ← θ - δ ( α \frac{\partial {L}_{C}}{\partial θ} + β \frac{\partial {L}_{DA}}{\partial θ} ) \qquad ( 8 )$$

where δ indicates the learning rate.

The high-level feature representations collected from the first stage are supposed to be used for anomaly detection purposes using the one-class classifier module. Before feeding the features to the module, the high-dimensional features must be mapped into the 2D feature space. The t-SNE algorithm is exploited to map the features from the higher dimensional space into the lower one.

During the training process at the second stage, the parameters of Equation (3) are optimized. Note that in the second stage, two hyper-parameters need to be tuned as well. The first hyper-parameter is v, and the second hyper-parameter is the RBF kernel hyper-parameter, γ, where according to Equation (9) below:

$$k ( {Φ}_{i} , {Φ}_{j} ) = {e}^{- γ {‖ {Φ}_{i} - {Φ}_{j} ‖}_{2}} \qquad ( 9 )$$

where Φᵢ, Φⱼ represents the ith and jth feature samples and ∥·∥ is the L2 norm operator.

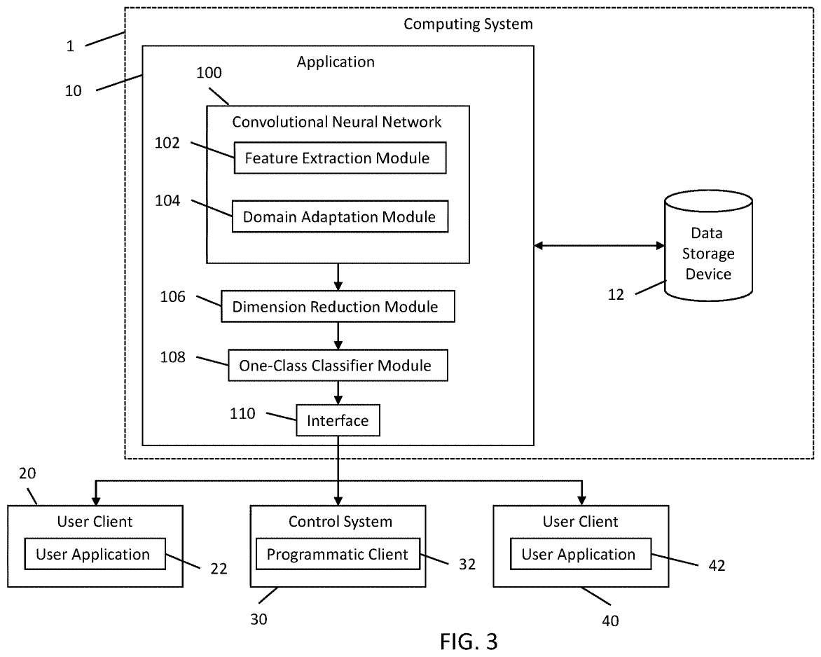

FIG. 3 shows an example of a system including the system for anomaly detection in an operational asset according to the present disclosure. The system shown in FIG. 1 may comprise a computing system 1, a user client 20, a control system 30, and a third party system 40. The computing system 1 may provide the system for data analysis, according to the present disclosure. The computing system 1 may be implemented using one or more general purpose computers, for example. As shown in FIG. 1, the computing system 1 may comprise an application 10 and a data storage device 12. The application 10 may be implemented by a software application including instructions that cause a computer to perform exemplary processes of the computing system. As shown in FIG. 1, the application 10 may comprise a CNN 100 with a feature extraction module 102 and a domain adaptation module 104, a dimension reduction module 106, a one-class classifier module 108, and an interface 110.

The CNN 100 may be the same or similar to the CNN illustrated in FIG. 2A and may be an artificial neural network having an input layer (e.g., Input Data from FIG. 2A), an output layer (e.g., Fully Connected layer from FIG. 2A) and a plurality of hidden layers (e.g., Convolutional Layer 1, Convolutional Layer 2, Pooling Layer 1, and Flatten layer from FIG. 2A) in between the input and output layers. The CNN 100 may be trained for processing any type of data, such as, for example, sensor data from an operational or industrial asset. In an example, the CNN 100 may be trained for processing data obtained by respective sensors, using a training dataset including possible input data to the CNN 100. The training dataset may be stored in the data storage device 12 accessible by the application 10.

The feature extraction module 102 and domain adaptation module 104 may be connected to at least one of the plurality of hidden layers of the CNN 100 and be configured to extract features from the input data, wherein a first subset of features is discriminative of the healthy class and a second subset of features is domain invariant. The details of the process performed by the feature extraction module are described above with respect to method steps S104-S110. The dimension reduction module 106 may be configured to perform the method step S112 described above. The one-class classifier module 108 may be configured to perform the method steps S114-S116 described above.

The interface 110 may be an interface for the application 10 to communicate with various devices that may be provided outside the computing system 1. For example, the interface 110 may be configured to communicate information generated by the application 10 to those devices. Further, for example, the interface 110 may be configured to receive information directed to the application 10 from those devices.

The data storage device 12 may be configured to store data that is used by the application 100. Although FIG. 3 shows the data storage device 12 to be a part of the computing system 1, in some examples, the data storage device 12 may be provided outside the computing system, as long as the data stored in the data storage device 12 is accessible by the application 10.

The user client 20 may be a client device connected to the computing system 1. The user client 20 may include a user application 22 that may use the predictions and the results of anomaly detection performed at the computing system 1, A specific example of the user client 20 may be a workstation remotely connected to a computational server, for instance using SSH (Secure Shell) or HTTP (Hypertext Transfer Protocol) requests. The CNN 100 can then be applied to user-provided input on the computational server and the resulting predictions and anomaly detections can be returned to the user client 20. The user client 20 may be part of the same physical device as the computing system 1 running the application 10, for instance on a workstation configured to perform CNN predictions.

The control and/or analysis system 30 may control a device and/or perform further data analysis using the predictions and the results of anomaly detection performed at the computing system 1. The control and/or analysis system 30 may constitute or be a part of a system for anomaly detection and/or for predictive maintenance. An example of the control and/or analysis system 30 may be a control and/or analysis system (such as for anomaly detection or predictive maintenance) of an operational asset such as a machine component or machine, an industrial process or plant, a vehicle (such as an autonomous vehicle), a computer network, a financial transaction unit, etc.

The control and/or analysis system 30 may comprise a programmatic client 32 running in the control and/or analysis system 30 receiving an input, performing data analysis and making decisions regarding further application specific actions, for example related to the maintenance of the operational asset (e.g. a piece of equipment or a system) and or related to the control of the operational asset (e.g. a piece of equipment or a system).

In addition, subject matter of the present disclosure can be implemented as the computing system 1 including a processor, and a memory coupled to the processor. The memory may encode one or more programs to cause the processor to perform one or more of the methods described herein. In some examples, the system 1 may be a general-purpose computer system. In other examples, the system 1 may be a special purpose computer system including an embedded system.

### Example

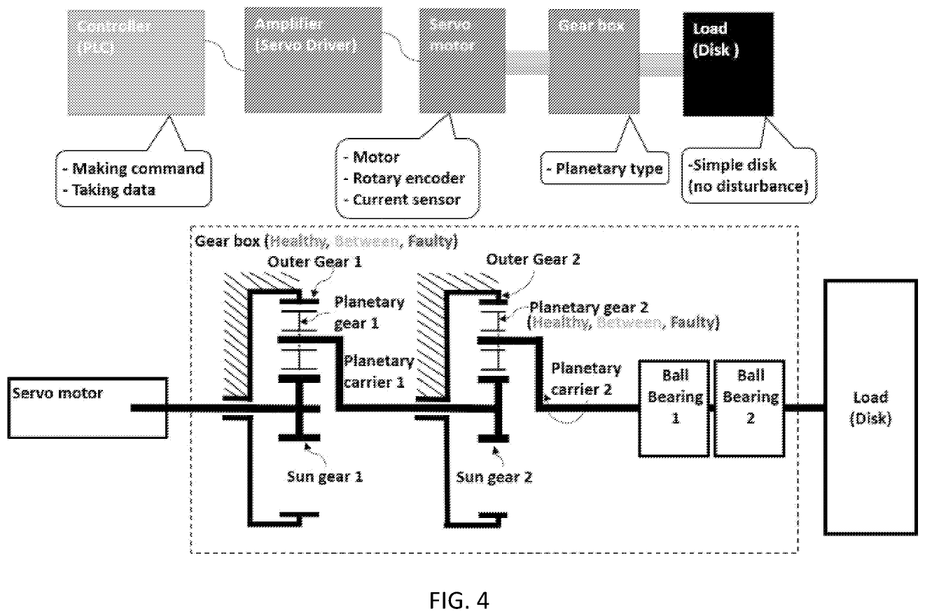

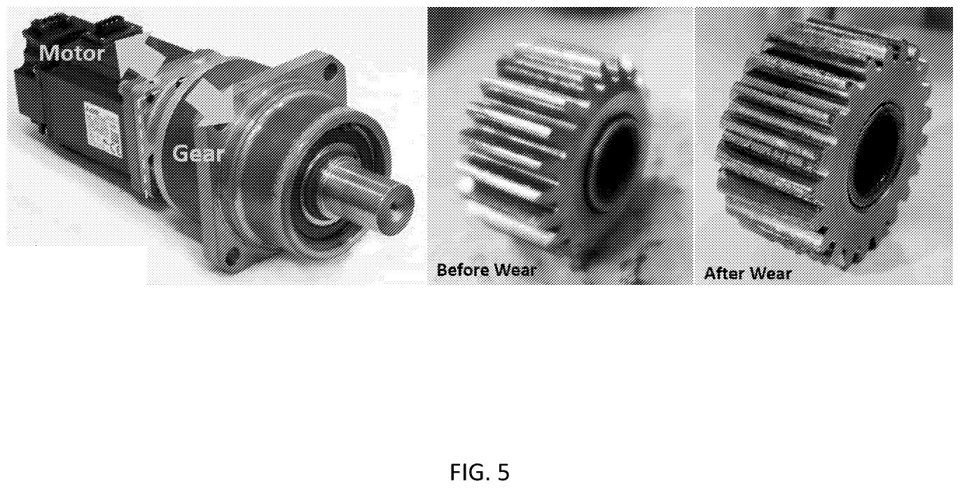

Gearbox data from an industrial system was analyzed. As shown in FIG. 4, the gearbox is part of a planetary gearbox system to transfer power from the motors to the loads. The dataset includes various combinations of gear health and gain settings. The fault mode for the gear is wear, and the conditions are healthy, between, and faulty. The studied gearbox and representative wear faulty condition of the gear are shown in FIG. 5. Between corresponds to an intermediate stage of gear wear between the healthy and faulty conditions. The possible gain settings are low, medium, and high. Gear wear faults are least pronounced in the low gain setting data, so distinguishing between the health conditions is most difficult. Therefore, the methods described in the present Example were first developed using the extreme case of low gain settings.

Each dataset includes fixed cycle feature test (FCFT) data. For purposes of the present Example, the focus of the dataset was on the steady state portions of the FCFT data rather than the transient portions. In total, 100 repetitions (loops) of 63 command patterns were collected for each wear/gain condition. The first 48 patterns are from the four main working regimes of 50 rpm, 500 rpm, 1000 rpm, and 3000 rpm (12 patterns for each regime). These patterns were generated by applying various rotational direction and position commands at the specified rpm. The remaining 15 patterns are similarly characterized by a certain rpm, rotational direction, and position command, but these remaining 15 patterns were not utilized in the present Example. In addition, based on the input from domain experts, the present Example only considered forward rotation (positive patterns), e.g., four patterns from each of the working regimes. That is, the backward rotations (negative patterns), were removed from the dataset during preprocessing. Ultimately, 100 loops of 32 patterns (eight from each rpm) were analyzed.

Every loop contains the command and feedback position, the command and feedback velocity, and the feedback torque current. Samples were collected every 444 μs. Auxiliary information (encoder temperature and load rate) was also collected for each loop at a rate of 1 Hz. The time and date stamp of each collected data point and the cumulative experiment time were available for each sampling frequency as well. A summary of the data collection information is provided in Table I below.

TABLE I
Detailed Data Collection Information

| | | |
|---|---|---|
| Signal | Unit | Sampling rate |

Main signals collected for each loop of the FCFT

| | | | |
|---|---|---|---|
| Command position | Encoder pulse count | 444 | μs |
| Feedback position | Encoder pulse count | 444 | μs |
| Command velocity | rpm | 444 | μs |
| Feedback velocity | rpm | 444 | μs |
| Feedback torque current | % of torque rate | 444 | μs |
| Total drive time | s | 444 | μs |

Auxiliary signals collected for each loop of the FCFT

| | | | |
|---|---|---|---|
| Encoder temperature | ° C. | 1 | s |
| Load rate | % of torque rate | 1 | s |
| Total drive time | s | 1 | s |

For preprocessing, the different loops and patterns were separated, resulting in a 100 loop×32 pattern matrix of samples. The samples initially contain both transient and steady state information. The first goal of preprocessing is to reduce the samples to contain only steady state components. To achieve this, all points of the feedback torque current signal corresponding to points where the command velocity of each sample is within one rpm of the working regime velocity were kept. The truncated torque samples were then further reduced to eliminate overshoot. After analyzing multiple loops and patterns, it was determined that the first 40% of each sample should be removed to leave only the steady state information. Finally, for each working regime, the eight cleaned patterns from each loop were concatenated, and then these 100 loops were concatenated. The result is one cleaned torque signal for each wear and gain condition for each working regime (36 signals in total).

The final step of preprocessing is to organize the torque signals into samples for the Example method described herein. Each torque signal was down-sampled by taking every 10th data point. The torque signal was then split into 500 windows of 2000 time-domain points each (2000 time-domain points will provide 1000 unique frequency-domain points). Step size and overlap percent for the windowing was determined dynamically based on the length of the overall torque signal. The frequency-domain information of each window was obtained and saved as a sample for the given wear, gain, and working regime combination. Overall, for each of the 36 conditions (three wear cases times three gain settings times four working regimes), 500 1000-point samples of frequency data for the cleaned steady state torque feedback current signal were generated.

To evaluate the performance of the methodology (e.g., method S100 described above), different tasks were designed based on different scenarios. Therefore, as indicated in Table II below, six different experiments were performed under different operating conditions. There are two main criteria for designing the tasks. The first criterion is evaluating the domain discrepancy by increasing the distance of the target operating condition from a fixed source condition (e.g., T1 and T2). The second criterion is evaluating the selection of the optimal source domain condition by interchanging the source and target domains for a particular task (e.g., T4 and T5). Note that in all experiments, the number of samples in the source and target domain datasets was 1500 (500 samples from each of the three health conditions).

TABLE II
Detailed Description of the Designed Experiments

| | | |
|---|---|---|
| Transfer task | Source domain | Target domain |

| | | | | |
|---|---|---|---|---|
| T1 | 50 | rpm | 1000 | rpm |
| T2 | 50 | rpm | 3000 | rpm |
| T3 | 500 | rpm | 1000 | rpm |
| T4 | 500 | rpm | 3000 | rpm |
| T5 | 3000 | rpm | 500 | rpm |
| T6 | 1000 | rpm | 50 | rpm |

With reference to the CNN architecture illustrated in FIG. 2A, the feature extractor module is comprised of two consecutive convolutional layers with 30 and 20 filters (filter size=5), respectively. The leaky rectified linear unit (ReLU) is utilized as the activation function in both convolutional layers. The convolutional layers are followed by a max pooling layer with a pooling size of 2. The detailed information of the network implementation and parameters are provided in Table III below.

TABLE III
Specification of Network Parameters

| Parameter | Value | Parameter | Value |
|---|---|---|---|
| δ | 1e−4 | Epochs | 500 |
| Neurons of FC layer | 128 | Drop-out rate | 0.5 |
| Batch size for cross- | 32 | Batch size for MMD | 100 |
| entropy | | | |
| Number of samples | 1500 | | |

To better evaluate the efficiency of the methodology of the present disclosure, a benchmarking study was performed. Therefore, different types of anomaly detection methods were applied under the scope of the designed transfer tasks and dataset. Afterward, the performance and accuracy of the method disclosed herein was compared to the other methods for each task. The following are the descriptions of the benchmarking methods:
Traditional one-class SVM: The main difference between the method of the present disclosure and the traditional one-class SVM is the input of the classifier. In the scope of the traditional one-class SVM, the raw frequency spectrum is used as the input of the classifier. The differences between the performance of the method presently disclosed herein and traditional one-class SVM substantiate the efficiency of the first stage of the presently disclosed method.
Isolation forest: This method is a non-parametric and unsupervised algorithm that can be used for detecting outliers in the dataset. When the input data space is high dimensional, discovering the healthy state pattern is not straightforward. In comparison with other similar methods, isolation forest provides high-quality anomaly detection capabilities.
Local outlier factor (LOF): This method provides a score that explains how likely it is that a sample is an outlier. This approach analyzes the local density deviation of the investigated samples with respect to their neighbors. The samples with relatively low density are considered as outliers.

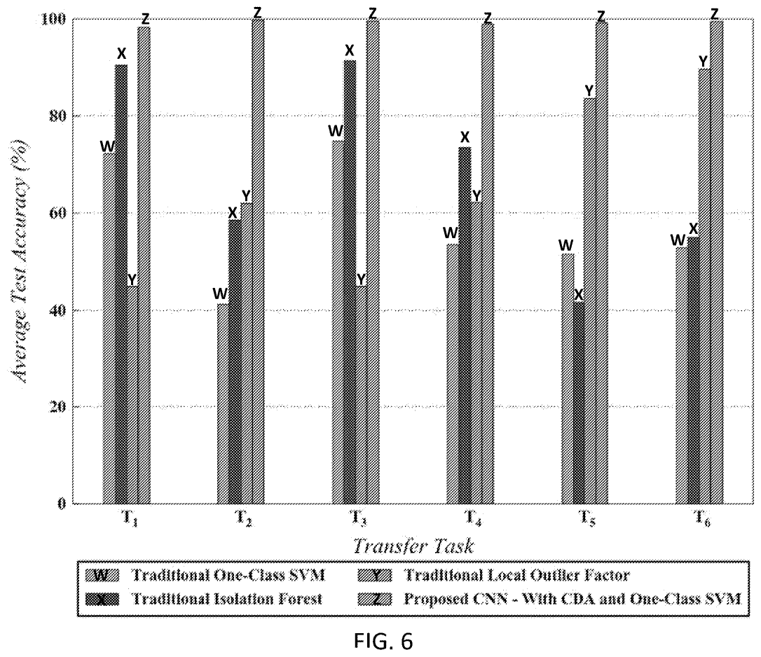

A comprehensive study was performed to validate the efficiency and effectiveness of the anomaly detection methodology described herein in comparison with other approaches. FIG. 6 shows the comparative evaluation of the studied methods under different experiments and tasks. As indicated by the results, the two-stage methodology of the present disclosure clearly outperforms the other methods. It should be noted that the effectiveness of the first stage of the method described herein can be validated by comparing it with the results of traditional one-class SVM. The only difference between these two approaches is the first stage of the method presently disclosed herein, and the comparative results substantiate a noticeable increase in the performance of the network when the one-class classifier is fed with domain-invariant and healthy class discriminative features.

Based on the first criterion of designing the transfer tasks, the experiments were conducted to evaluate the effect of domain discrepancy. In this regard, by comparing the results between Tasks T1 and T2 and between T3 and T4, as the distance between the operating conditions of the source and target domains increases, the performance of the network decreases. On the other hand, the selection of the source domain dataset also affects the performance of networks. As indicated in FIG. 6, by comparing the results between tasks T4 and T5 and between tasks T1 and T6, it can be concluded that although the domain discrepancy between source and target domains is constant, changing the source and target domains can influence the performance of the networks. In both scenarios, the network of the present disclosure is almost robust to these kinds of phenomena.

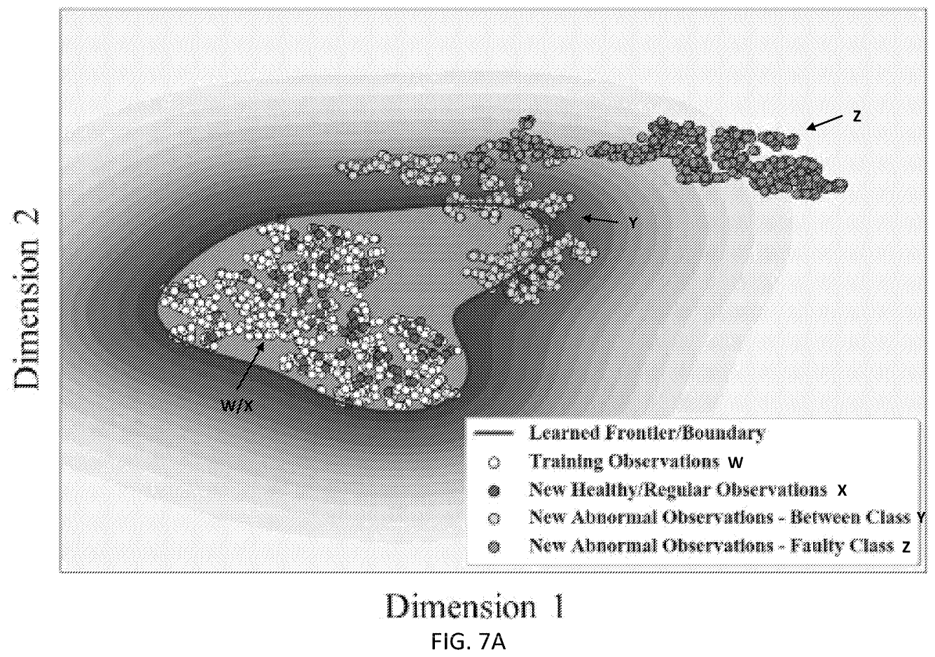

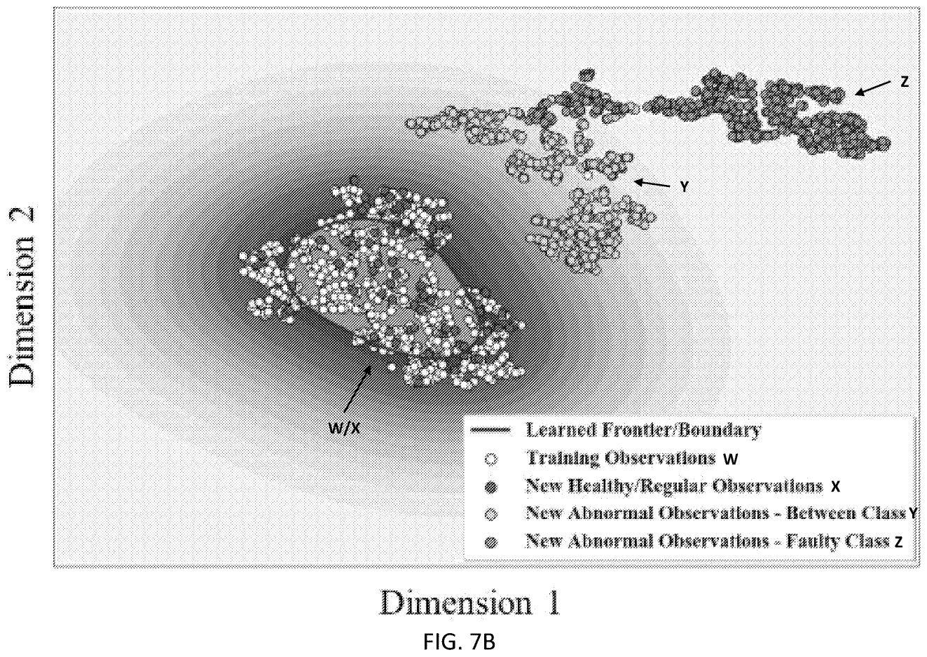

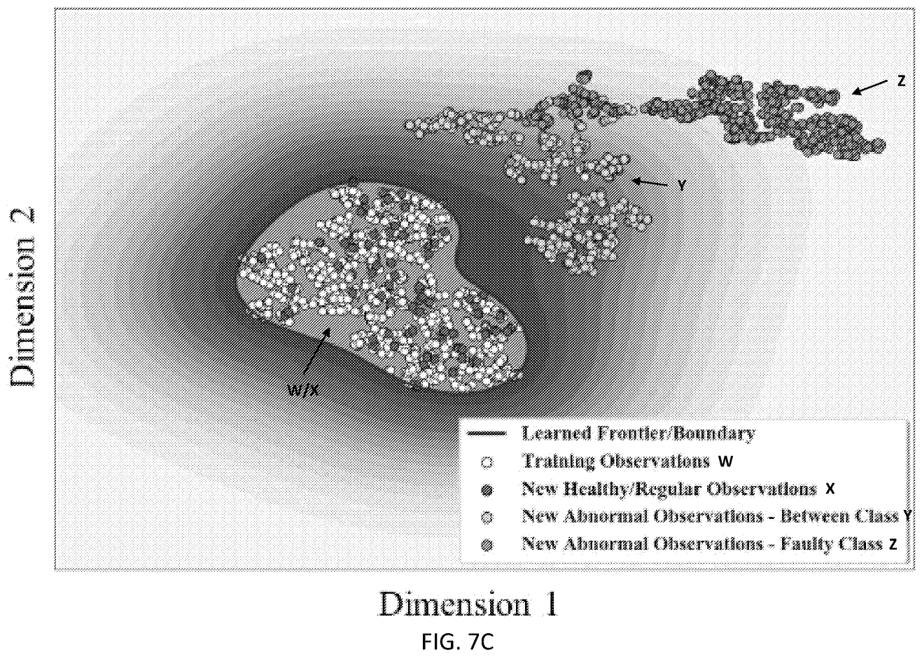

The value of the term v affects the number of samples considered as outliers. Tuning this hyper-parameter is an important step in designing the one-class classifier. The effect of the variation of the v value on the anomaly detection capability of the proposed network for task T2 is demonstrated in FIGS. 7A-7C. When the value of v is low, a smaller fraction of samples are considered as outliers. In other words, the model is overfitting (FIG. 7A). Contrarily, a higher value of v leads to a model underfitting issue (FIG. 7B). Based on the hyper-parameter tuning study, the optimum value for v is 0.01 where the network can properly distinguish the samples corresponding to the healthy state from the other two health conditions of the system (FIG. 7C).

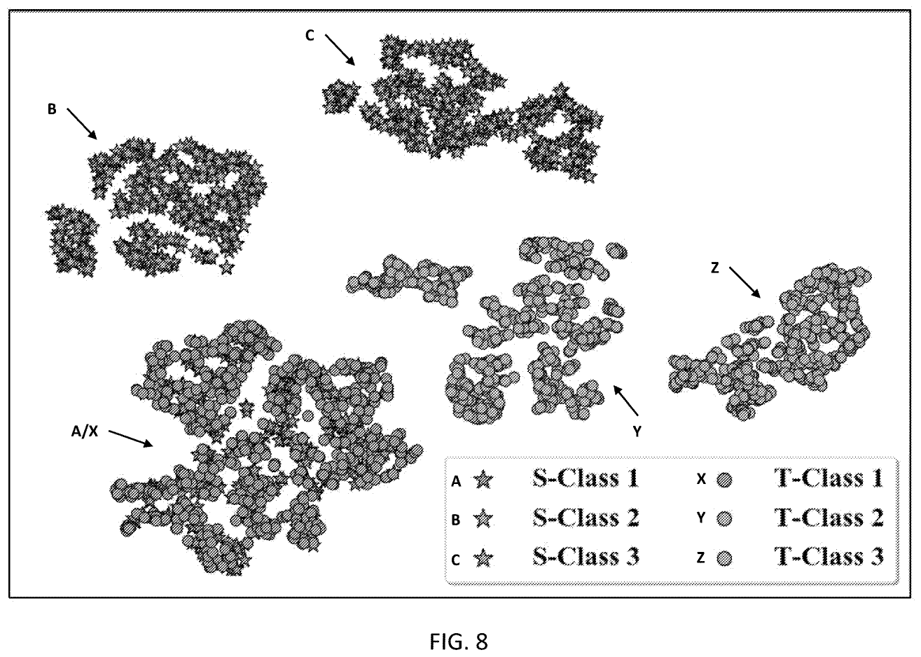

The features extracted from the first stage of the presently disclosed method are meant to be domain-invariant and healthy class discriminative. To have a better understanding of these two characteristics of the high-level features, the visualization of these features is demonstrated in FIG. 8. As can be seen from FIG. 8, the features corresponding to the healthy class of the source and target domains are clustered into the same group. Therefore, it can be concluded that the presently disclosed network at the first stage can extract the domain-invariant and healthy class discriminative features. Since the features are domain-invariant, they can be used for transfer learning applications and transfer the knowledge obtained from the source domain to the target domain. On the other hand, since the features are healthy class discriminative, they can be a suitable candidate for the input of any one-class classifier for the anomaly detection application.

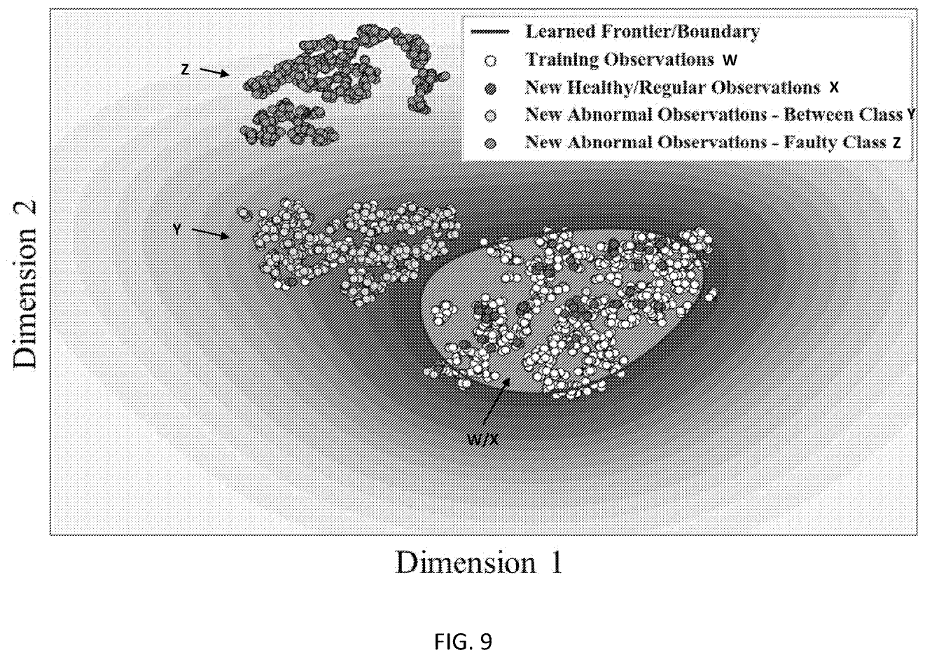

The extracted high-level features are utilized as the input of the one-class SVM for the anomaly detection application. The goal is to develop a pattern that separates the healthy class samples in the target domain from the other two classes. The visualization of the one-class classifier using the proposed method for Task T5 is demonstrated in FIG. 9. As shown in FIG. 9, the one-class classifier can properly cluster the healthy class samples of both domains in the same group while the samples corresponding to the other two classes are considered as outliers. It should be noted that as the faults get more severe and the system health state moves to the faulty class, the features are located farther away from the healthy class boundary.

In view of the above, it should now be understood that at least some embodiments of the present disclosure are directed to a two-stage deep learning-based transfer learning methodology to be used for anomaly detection. One differentiating characteristic of the methodology disclosed herein lies within the first stage of the architecture, which as described above, provides the domain-invariant and healthy class discriminative features. Using the methodology disclosed herein, the knowledge obtained from the source domain dataset under one operating condition can be exploited to distinguish the outliers in the target domain dataset under another operating condition. In this scenario, only a small amount of data corresponding to the health state of the system is available for the target domain.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method for anomaly detection in an operational asset, comprising:
collecting a source domain dataset corresponding to a first operating condition of the operational asset, wherein samples from the source domain dataset belong to a healthy class, and a faulty class;
collecting a target domain dataset corresponding to a second operation condition of the operational asset, wherein samples from the target domain dataset belong to the healthy class;
inputting the source domain dataset and the target domain dataset as input data into a neural network;
extracting, by the neural network, features from the input data, wherein the features are domain-invariant and discriminative of the healthy class;
reducing a dimensionality of the features into reduced features; and
classifying the reduced features into a normal class and an anomaly class using a one-class classifier.

2. The method of claim 1, further comprising preprocessing the source domain dataset and the target domain dataset by data truncation.

3. The method of claim 1, wherein a first subset of features is discriminative of the healthy class and extracted by applying a cross-entropy loss optimization on the source domain dataset.

4. The method of claim 1, wherein a second subset of features is domain-invariant and extracted by applying a domain adaptation loss optimization on the source domain dataset and the target domain dataset.

5. The method of claim 4, wherein the domain adaptation loss optimization utilizes maximum mean discrepancy loss.

6. The method of claim 1, wherein the dimensionality of the features is reduced by t-distributed stochastic neighbor embedding.

7. The method of claim 1, wherein the one-class classifier is a support vector machine classifier.

8. A system for anomaly detection in an operational asset, comprising:
one or more processors; and
a non-transitory computer-readable medium storing instructions that, when executed by the one or more processors, cause the one or more processors to:
receive a source domain dataset corresponding to a first operating condition of the operational asset, wherein samples from the source domain dataset belong to a healthy class, and a faulty class;
receive a target domain dataset corresponding to a second operation condition of the operational asset, wherein samples from the target domain dataset belong to the healthy class;
input the source domain dataset and the target domain dataset as input data into a neural network;
extract, by the neural network, features from the input data, wherein the features are domain-invariant and discriminative of the healthy class;
reduce a dimensionality of the features into reduced features; and
classify the reduced features into a normal class and an anomaly class using a one-class classifier.

9. The system of claim 8, further comprising preprocessing the source domain dataset and the target domain dataset by data truncation.

10. The system of claim 8, wherein a first subset of features is discriminative of the healthy class and extracted by applying a cross-entropy loss optimization on the source domain dataset.

11. The system of claim 8, wherein a second subset of features is domain-invariant and extracted by applying a domain adaptation loss optimization on the source domain dataset and the target domain dataset.

12. The system of claim 11, wherein the domain adaptation loss optimization utilizes maximum mean discrepancy loss.

13. The system of claim 8, wherein the dimensionality of the features is reduced by t-distributed stochastic neighbor embedding.

14. The system of claim 8, wherein the one-class classifier is a support vector machine classifier.

15. A method for repairing an operational asset, comprising:
collecting a source domain dataset corresponding to a first operating condition of the operational asset, wherein samples from the source domain dataset belong to a healthy class, and a faulty class;
collecting a target domain dataset corresponding to a second operation condition of the operational asset, wherein samples from the target domain dataset belong to the healthy class;
inputting the source domain dataset and the target domain dataset as input data into a neural network;
extracting, by the neural network, features from the input data, wherein the features are domain-invariant and discriminative of the healthy class;
reducing a dimensionality of the features into reduced features;
classifying the reduced features into a normal class and an anomaly class using a one-class classifier;
identifying at least one operational asset within the anomaly class; and
repairing the at least one operational asset.

16. The method of claim 15, wherein a first subset of features is discriminative of the healthy class and extracted by applying a cross-entropy loss optimization on the source domain dataset.

17. The method of claim 15, wherein a second subset of features is domain-invariant and extracted by applying a domain adaptation loss optimization on the source domain dataset and the target domain dataset.

18. The method of claim 17, wherein the domain adaptation loss optimization utilizes maximum mean discrepancy loss.

19. The method of claim 15, wherein the dimensionality of the features is reduced by t-distributed stochastic neighbor embedding.

20. The method of claim 15, wherein the one-class classifier is a support vector machine classifier.
